(19) United States
(12) Patent Application Publication
(10) Pub. No.: US 2002/0161719 A1
(43) Pub. Date: Oct. 31, 2002

(54) Method of and apparatus for on-line enrolment

(76) Inventors: David Franklin Manning, Victoria (CA); Michael Cain Mansell, Victoria (CA); John Michael Boyer, Victoria (CA); Theodore Edward Neustaedter, Sooke (CA); Richard William Reeve Bennett, Sooke (CA); Bradley Michael Debroni, Victoria (CA); Michael Graham Rowling, Saltspring (CA); Randall Joseph Kapuscinski, Whitby (CA)

Correspondence Address: Gowling Lafleur Henderson LLP, Suite 2600, 160 Elgin Street, Ottawa, ON, K1P 1C3, CA

(21) Appl. No.: 09/842,661

(22) Filed: Apr. 27, 2001

(51) Int. Cl. H04K 1/00; H04L 9/00; G06F 17/60

(52) U.S. Cl. 705/64

(57) ABSTRACT

A system for on-line enrolment includes an application server for controlling and communicating with an end-user and an institution with which the end-user desires to enroll. The application server has an evaluation service for providing workflow and logic in accordance with the institution's business criteria. When initiated by an end-user a management server determines and downloads appropriate client software to the end-user, which includes a signing agent, that allows the end-user to digitally sign the business agreements needed to complete an account enrolment with an institution such as a bank, stock broker or other financial institution. A verification service authenticates information provided by the end-user. A certificate service sends a digital certificate to an end-user. An evaluation service receives a digitally signed electronic business agreement from the end-user to complete enrolment of the end-user and forms a complete enrolment package. An audit service creates a log of all transaction records. A payment service may be included to effect payment from the end-user to the institution. An e-business archive stores the complete enrolment package.

### FIELD OF THE INVENTION

The present invention relates to method and apparatus for on-line enrolment and is particularly concerned with secure transactions.

### BACKGROUND OF THE INVENTION

The success browser technology made the Internet accessible to users of personal computers and heralded a new era for on-line activity. Initially many companies merely ported their brochures and catalogues over to the new media. This gave the companies a new vehicle for one-way communication of their company and product information. It also afforded the end-user an opportunity to acquire information quickly. Once product information was acquired and suitable selections made, tradition methods were employed to effect business transactions.

Commerce on the Internet fairly quickly evolved, especially in the business-to-business area to allow major purchases of goods and services for existing account holders. However, contracts governing these accounts must be executed via traditional paper methods. With established customers and for large business clients this may not be a problem. However, when the business-to-business models are extended to consumers or small business transactions a high attrition rate is seen in the enrolment process. Any process that requires execution of paper documents to complete the enrolment process may see an attrition rate of 50% or more. Existing “On-line Enrolment” Solutions still involve a manual process. These processes allow an end-user to input personal data in an application form, however at some point in the process the applicant's signature must be affixed to either a printed copy of the on-line form or on paper confirmation sent to the applicant by mail for execution and return.

Hence the typical process for on-line enrolment is:

The Stop-Gap Enrolment Process: Delaying the Pain of Paper

The Applicant provides preliminary personal information on-line

The Investment Firm provides a $1000-2000 credit until the application is completely processed

The Application receives an enrolment package with application forms, which they are required to sign and mail to the Investment Firm to complete the enrolment process

Fifty percent of applicants do not mail the package and complete the enrolment process.

### SUMMARY OF THE INVENTION

An object of the present invention is to provide an improved on-line enrolment system and method.

Accordingly, the present invention provides a method and system for complete on-line end-user new account enrolment.

According to an aspect of the present invention there is provided a method of on-line enrolment comprising the steps: receiving a communication from an end-user with regard to an institution with which the end-user desires to enroll; invoking an evaluation service for providing workflow and logic in accordance with the institution's business criteria; communicating with the desired institution as dictated by the evaluation service; determining and downloading appropriate client software to the end-user, the client software including a signing agent; authenticating information provided by the end-user; deploying digital certificates to the end-user for signing electronic business agreements, effecting payment from the end-user to the institution, collecting all transaction records into a complete enrolment package, and archiving the complete enrolment package.

According to another aspect of the present invention there is provided a system for on-line enrolment comprising: an application server for controlling and communication with an end-user and an institution with which the end-user desires to enroll and having an evaluation service for providing workflow and logic in accordance with the institution's business criteria; a management server for determining and downloading appropriate client software to the end-user, the client software including a signing agent; a verification service for authenticating information provided by the end-user; a certification service for managing digital certificates, a payment service for effecting payment from the end-user to the institution, an audit service for collecting all transaction records into a complete enrolment package, and an e-business archive for archiving the complete enrolment package.

### BRIEF DESCRIPTION OF THE DRAWINGS

These and other features of the invention will become more apparent from the following description in which reference is made to the appended drawings in which:

FIG. 1 illustrates in a block diagram, a system for on-line enrolment of a client with an institution in accordance with an embodiment of the present invention; and

FIG. 2 illustrates in a block diagram a method of enrolment for the system of FIG. 1 in accordance with an embodiment of the present invention.

### DETAILED DESCRIPTION OF THE PREFERRED EMBODIMENT

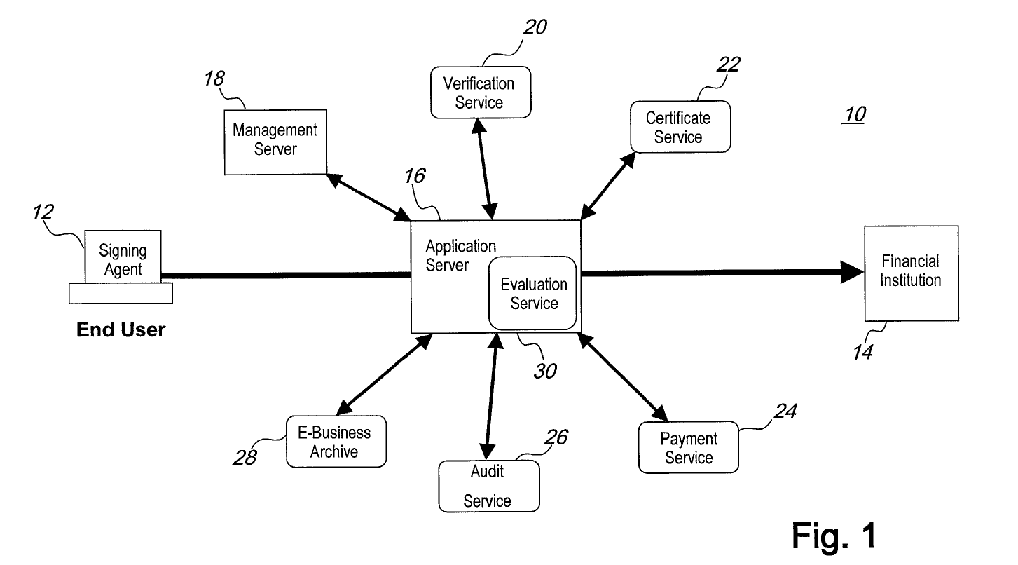

Referring to FIG. 1, there is illustrated in a block diagram, a system for on-line enrolment of a client with an institution in accordance with an embodiment of the present invention. The system 10 allows an end-user 12 to enroll with an institution 14 using and on-line process. The system 10 includes an application server 16, a management server 18, a verification service 20, a certificate service 22, a payment service 24, an audit service 26, and an e-business archive 28. The application server 16 includes an evaluation service 30.

In operation, the application server 16 provides the control and communication center between the end-user 12, the institution 14 and enrolment services provided by the management server 18, the verification service 20, the certificate service 22, the payment service 24, the audit service 26, and the e-business archive 28. The application server 16 provides dynamic interfaces with the end-user 12, captures the end-user's personal information in a local database for later long-term storage and transmission to the institution 14. The application server 16 includes the evaluation service 30 for customized workflow and logic according to the institution's specific business criteria. When the end user 12 initiates on-line enrolment, the application server 16 automatically redirects the end-user to the management server 18, which deploys a signing agent to the end-user's desktop. The management server 18 downloads a specific version of software by determining the end-user's browser type. The client-side software is downloaded and installed with minimal involvement from the end-user. This process starts automatically and proceeds in the background while the end-user continues to provide enrolment information. The client side XML software that enables users to read and sign electronic business agreements is based on unique XFDL technology to capture context, content, and presentation of the agreement. XFDL is based on XML open standards.

The verification service 20 provides real-time authentication of information provided by the user with a third-party source. Different levels of verification are available, depending on the financial institution's unique business criteria. The verification service 20 confirms the end-user's identity and checks the end-user's credit history.

The evaluation service 30 controls workflow and business logic in application server 16 and makes real-time enrolment decisions based on the business criteria of the financial institution. Other functions provided by the evaluation service 30 include approving end-users for account enrolment based on results from the verification service 20 and may include determining the level of digital certificate required for enrolment.

The certificate service 22 manages revocation, expiration and renewal of digital certificates. The certificate service 22 deploys digital certificates to end-users for signing electronic business agreements. Typically any available public key infrastructure (PKI) can be used.

The payment service 24 may communicate with a third party clearing house, according to the financial institution's business criteria. The user may, for example, initiate an electronic funds transfer (EFT).

The audit service 26 collects records of every transaction and provides final evidence of individual's intent and authenticity in enrolment process. The centralized audit service collects transaction records from all of the enrolment services. The audit service captures records of every system transaction for digital evidence and provides audit reports such as monthly enrolment statistics. All records are stored in the e-business archive 28.

The e-business archive 28 manages archival and retrieval of complete enrolment packages. The e-business archive 28 records complete enrolment package onto write-once read-many (WORM) media. The complete enrolment package includes: the end-users digitally signed business agreements, the report from verification service 20 and related transaction files from the audit service 26. Typically, the complete enrolment package is first encrypted and then archived. The system operator serves as custodian of records, but cannot access contents of the archive. The system operator can only testify that records have not been altered. The system has been designed to meet the stringent standards of SEC 17-A. Hence, following the registration process (corresponding to the point at which the end-user has submitted the final document), all of the documents submitted by the end-user are encrypted and archived in a manner that conforms to SEC regulations. Additional documents, such as the results of a credit check, are also archived. The governing SEC regulations are outlined in Section 4.1.2.1 Regulatory Requirements-SEC.

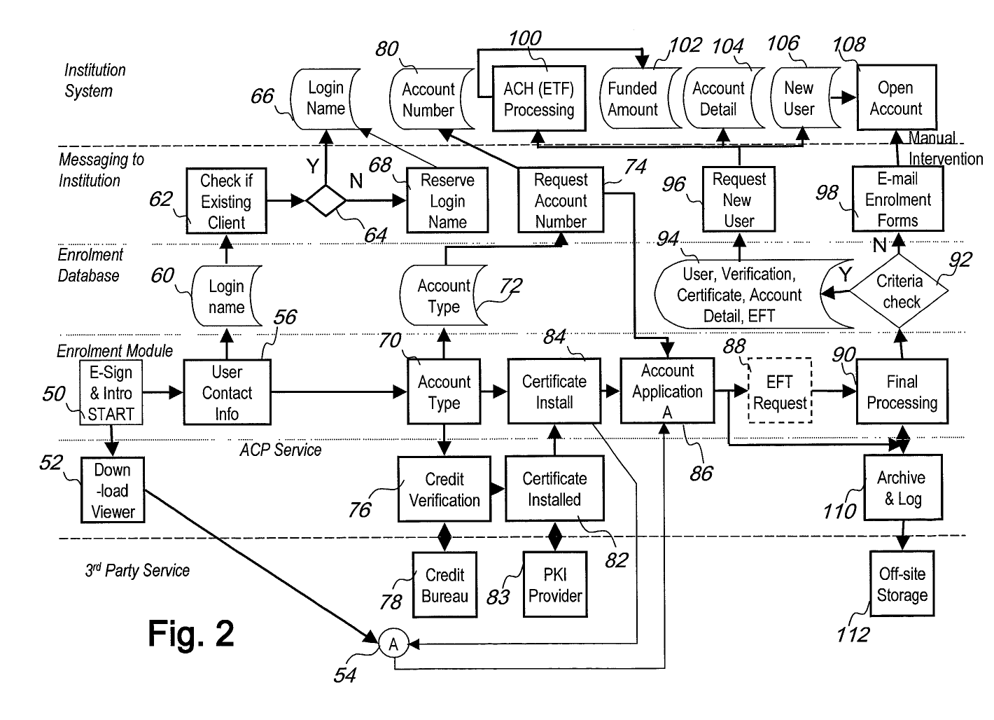

Referring to FIG. 2, there is illustrated in a block diagram a method of enrolment for the system of FIG. 1 in accordance with an embodiment of the present invention. An end-user browsing and institutions website is invited to open a new account. From the end user's viewpoint the process involves only five steps. They are:

1. Software installation

2. Provide basic personal information

3. Get a digital certificate

4. Complete account application agreements

5. Receive confirmation of enrolment

For the system of FIG. 1, the process begins with the enrolment module at a block 50, E-sign and Intro Start. Typically this is in response to the end-user making a mouse click on an “enroll now” button on the institutions website. At the enrolment module's request, the management servicer downloads a viewer, also known as a signing agent, at block 52 to an end-user A, 54. The enrolment module then collects user contact information at a block 56 and passes this information on to login name storage 60. A message is sent to the institution at a block 62 to check if end-user A is an existing member by a decision block 64. If yes, the login name is verified at a block 66 with the one stored by the institution, if No, a block 68 reserves the login name. A block 70 receives account type information and passes it to the enrolment database at a block 72, who in turn passes it to a request account number 74 and to a credit bureau verification block 76. The credit bureau verification block 76 passing the end-user information to a third party credit bureau as represented by a block 78. The credit bureau check is passed back to the credit bureau verification block 76 and then to a Certificate block 82, where a certificate is obtained from the public key infrastructure provider at a block 83 in dependence upon the result of the credit bureau check at the block 78. The block 82 then provides the certificate to a block 84 that installs the certificate to the browser of the end-user 54 for receipt of the collected end-user and account information at a block 86. The end-user 54 submits the signed XFDL forms and may initiate the request for electronic funds transfer by completing and signing an additional XFDL form as represented by a block 88. Final processing of all of the enrolment data is then effected by the enrolment module as represented by a block 90, following criteria checking as represented by a block 92, the enrolment data is stored in the enrolment database as represented by a block 94 and a new user request message is sent as represented by a block 96. In response to the request the institution carries out a number of steps to establish a new account, as represented for example by the steps of 100 processing the fund transfer, storing the amount funded at block 102, the account detail at block 104 and new user information at block 106 and opening of a new account at 108. The entire process can be effected “on-line” if the business criteria set by the institution are met. However, if the criteria is negative at block 92, e-mail enrolment forms may be sent to the institution to effect opening of a new account using manual intervention (not shown in FIG. 2). At a block 110, the audit service collects a central audit file, which it sends to the e-business archive as represented by a block 112. The e-business archive receives the audit record and bums it to WORM media.

Before the user can access or fill-out the required documents, they need to have a valid digital certificate. The system issues certificates to those customers who indicate they do not already have one on the computer they are currently using (customers may still have valid certificates from previous use of the system).

Users who already have a valid digital certificate on the computer they are currently using can indicate they want to skip the certificate installation step.

Certificates are generated based on the user's name and e-mail address. Note that depending upon the browser being used, the user may have to respond to a confirmation dialog during certificate installation when the local certificate store is accessed on the applicant's system.

Before a user can complete the account registration process they are subjected to a verification procedure to:

Ascertain that they are who they claim to be by validating the demographic information they have provided (a “social search”);

Verify their financial status and history (a “credit check”—only applied in some situations);

Verify that the user passes criteria defined by the institution for certain account types (a “criteria check”).

Typically, the verification service 20 conducts a social search and credit check through a 3^{rd} party agency. The decision logic employed is configurable.

The evaluator service 30 conducts the criteria check is incorporated as part of the System, based on logic provided by the institution that evaluates information the user has supplied.

At all times the system will clearly indicate when the possibility exists of a credit check being performed, and will request the user's authorization prior to performing such checks.

The applicant will always be allowed to complete the application process, regardless of the outcome of the verification process.

As mentioned herein above, the system has been designed to meet the stringent standards of SEC 17-A. More specifically the SEC Rules that govern the use of Electronic Storage Media are contained in the Apr. 14, 1997 amendments to Rule 17a-4 of the Securities Exchange Act of 1934. Rules 17a-3 and 17a-4 are the master guideline for records retention. They detail the records that exchange members, brokers, and dealers are required to retain, and how long they are required to retain them. These amendments now add information on how they can store these records electronically. The common name for this amendment is:

“Reporting Requirements for Brokers and Dealers Under the Securities Exchange Act of 1934,”

and the amendment is known as:

SECURITIES AND EXCHANGE COMMISSION

17 CFR Part 240

[Release No. 34-38245; File No. S7-21-93] RIN 3235-AF91

Where CFR stands for “Code of Federal Regulations” and RIN stands for “Regulation Identifier Number”. The “release no.” and “file no.” are agency docket and tracking numbers.

When the institution requires enrolment documentation from the archive, they send a request to the enrolment system indicating the unique user identifier that was provided when the enrolment documentation was originally archived. The enrolment system then accesses the archive, retrieves the required information and sends it to the institution. Once retrieved, the institution can then decrypt the archive package using a software utility.

The archive contains metadata to allow the SEC or other approved agency access to the archive data. Numerous modifications, variations and adaptations may be made to the particular embodiments of the invention described above without departing from the scope of the claims, which is defined in the claims.

What is claimed is:

1. A method of on-line enrolment comprising the steps:
receiving a communication from an end-user with regard to an institution with which the end-user desires to enroll;
invoking an evaluation service for providing workflow and logic in accordance with the institution's business criteria;
communicating with the desired institution as dictated by the evaluation service;
determining and downloading appropriate client software to the end user, the client software including a signing agent;
authenticating information provided by the end-user;
deploying a digital certificate to the end-user for signing to effect an electronic business agreement;
receiving a digitally signed electronic business agreement from the end-user to complete enrolment of the end-user; and
collecting all transaction records into a complete enrolment package.

2. A method as claimed in claim 1 further comprising the step of encrypting the complete enrolment package

3. A method as claimed in claim 1 further comprising the step of archiving the complete enrolment package.

4. A method as claimed in claim 1 further comprising the step of encrypting and archiving the complete enrolment package.

5. A method as claimed in claim 1 further comprising the step effecting payment from the end-user to the institution.

6. A system for on-line enrolment comprising:
an application server for controlling and communicating with an end-user and an institution with which the end-user desires to enroll and having an evaluation service for providing workflow and logic in accordance with the institution's business criteria;
a management server for determining and downloading appropriate client software to the end-user, the client software including a signing agent;
a verification service for authenticating information provided by the end-user;
a certificate service for managing a digital certificate for an end-user;
an evaluation service for receiving a digitally signed electronic business agreement from the end-user to complete enrolment of the end-user by forming a complete enrolment package; and
an audit service for collecting all transaction records.

7. Apparatus as claimed in claim 6 including a payment service for effecting payment from the end-user to the institution.

8. Apparatus as claimed in claim 6 including an e-business archive for storing the complete enrolment package.

9. Apparatus as claimed in claim 6 wherein the application server includes an encryption algorithm for encrypting the complete enrolment package.
